(19) United States
(12) Patent Application Publication
(10) Pub. No.: US 2025/0205891 A1
(43) Pub. Date: Jun. 26, 2025

(54) ROBOT CONTROL WITH LIMITATION OF CONTROL QUANTITY

(71) Applicant: KABUSHIKI KAISHA YASKAWA DENKI, Kitakyushu-shi (JP)

(72) Inventor: Shunsuke SUZUKI, Fukuoka (JP)

(21) Appl. No.: 18/985,022

(22) Filed: Dec. 18, 2024

(30) Foreign Application Priority Data
Dec. 22, 2023 (JP) 2023-216726

(51) Int. Cl. B25J 9/16

(52) U.S. Cl. CPC B25J 9/1664

(57) ABSTRACT

A robot system includes: a robot including one or more motors configured to move an arm; and circuitry configured to: control at least one motor of the one or more motors so that a first control quantity follows a first control command, wherein the first control quantity represents a physical status of the arm; and limit the first control command based on a second control quantity that is an integral of the first control quantity.

### CROSS-REFERENCE TO RELATED APPLICATIONS

This application is based upon and claims the benefit of priority from Japanese Patent Application No. 2023-216726, filed on Dec. 22, 2023, the entire contents of which are incorporated herein by reference.

### BACKGROUND

### Field

The present disclosure relates to a robot system and a control method.

### Description of the Related Art

Japanese Unexamined Patent Publication No. H03-184786 discloses a device comprising a force detection unit for detecting a force acting on a robot and an object, a position detection unit for detecting the current position of the robot, a position control unit for controlling the position of the robot based on the position coordinates of the position detection unit, a force control unit for controlling a force applied to the robot based on the force detected by the force detection unit, a control command generation unit for transferring force/position commands and various parameters to the robot, a normal vector calculation unit for calculating the normal vector of the contact point between the robot and the object and calculating a profile coordinate system, and a movement direction vector calculation unit for calculating a movement direction vector of the robot along the profiling coordinate system, the device performing a profiling operation on a surface of the object with an unknown curved surface while applying a constant force by the force control unit based on the calculated profile coordinate system.

### SUMMARY

Disclosed herein is a robot system. The robot system may include: a robot including one or more motors configured to move an arm; and circuitry configured to: control at least one motor of the one or more motors so that a first control quantity follows a first control command, wherein the first control quantity represents a physical status of the arm; and limit the first control command based on a second control quantity that is an integral of the first control quantity.

Additionally, a control method for controlling a robot comprising one or motors configured to move an arm is disclosed herein. The control method may include: controlling at least one motor of the one or more motors so that a first control quantity follows a first control command, wherein the first control quantity represents a physical status of the arm; and limiting the first control command based on a second control quantity that is an integral of the first control quantity

### BRIEF DESCRIPTION OF THE DRAWINGS

FIG. 1 is a schematic diagram illustrating an example configuration of a robot system.

FIG. 2 is a graph illustrating an example limit value that decreases as the second control quantity increases.

FIG. 3 is a schematic diagram illustrating an example approach operation.

FIG. 4 is a schematic diagram illustrating an example search operation.

FIG. 5 is a schematic diagram illustrating an example search operation.

FIG. 6 is a schematic diagram illustrating an example search operation.

FIG. 7 is a block diagram illustrating an example hardware configuration of a controller.

FIG. 8 is a flowchart illustrating an example motor control procedure.

FIG. 9 is a flowchart illustrating an example teaching operation procedure.

FIG. 10 is a flowchart illustrating an example playback control procedure.

FIG. 11 is a flowchart illustrating another example teaching operation procedure.

FIG. 12 is a flowchart illustrating an example screw tightening control procedure.

### DETAILED DESCRIPTION

In the following description, with reference to the drawings, the same reference numbers are assigned to the same components or to similar components having the same function, and overlapping description is omitted.

### Robot System

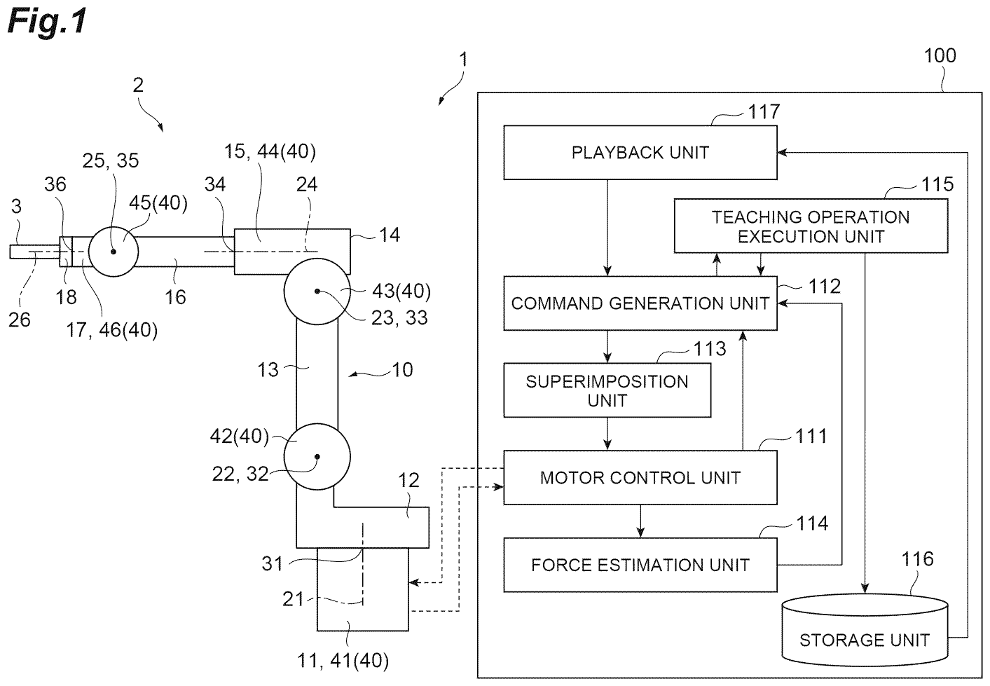

As illustrated in FIG. 1, a robot system 1 is a system for causing a robot 2 to perform tasks on a workpiece. Examples of tasks on a workpiece include transporting the workpiece, processing the workpiece, and assembling the workpiece. Examples of processing the workpiece include grinding and polishing the workpiece. Examples of assembling the workpiece include fastening multiple parts (parts of the workpiece) together with bolts and joining multiple parts together by welding.

The robot system 1 includes the robot 2 and a control device 100. The robot 2 is, for example, an industrial vertical articulated robot having a multi-joint arm 10 and an end effector 3. The arm 10 changes the position and posture of the end effector 3 through multi-joint movements.

The end effector 3 is attached to the tip of the arm 10 and acts on the workpiece. Examples of the end effector 3 include a suction nozzle for holding the workpiece, a hand for gripping the workpiece, a grinding tool for grinding the workpiece, a polishing tool for polishing the workpiece, a screw tightening tool (for example, a driver or wrench) for tightening screws (for example, bolts), a welding gun for spot welding, a welding torch for arc welding, and a painting gun for painting, but are not limited to these examples.

For example, the arm 10 includes a base 11, a rotational portion 12, a first arm 13, a second arm 14, a third arm 17, a distal end portion 18, and one or more motors 40. The base 11 is installed on the floor of a work area, for example. The base 11 may be installed on a moving body such as an automated guided vehicle that moves within the work area.

The rotational portion 12 is provided on the base 11 to rotate about a vertical axis 21. The first arm 13 is connected to the base 11 to swing about an axis 22 intersecting (for example, orthogonal to) the axis 21 and extends in a direction away from the axis 22. The intersection includes a skewed relationship, such as a three-dimensional intersection. The same applies hereinafter.

The second arm 14 is connected to the end of the rotational portion 12 to swing about an axis 23 parallel to the axis 22. The second arm 14 includes an arm base 15 and an arm end 16. The arm base 15 extends in a direction away from the axis 23. The second arm 14 is connected to the end of the arm base 15 to rotate about an axis 24 along the center axis of the arm base 15 and extends further along the axis 24 from the arm base 15.

The third arm 17 is connected to the end of the arm end 16 to swing about an axis 25 intersecting (for example, orthogonal to) the axis 24 and extends in a direction away from the axis 25. The distal end portion 18 is connected to the third arm 17 to rotate about an axis 26 along the center axis of the third arm 17. The distal end portion 18 is a aprt of an end portion of the arm 10. The end effector 3 is attached to the distal end portion 18 to be a part of the end portion of the arm 10.

Thus, the arm 10 includes a joint 31 that allows the rotational portion 12 to rotate about the axis 21 relative to the base 11, a joint 32 that allows the first arm 13 to swing about the axis 22 relative to the rotational portion 12, a joint 33 that allows the arm base 15 to swing about the axis 23 relative to the first arm 13, a joint 34 that allows the arm end 16 to rotate about the axis 24 relative to the arm base 15, a joint 35 that allows the third arm 17 to swing about the axis 25 relative to the arm end 16, and a joint 36 that allows the distal end portion 18 to rotate about the axis 26 relative to the third arm 17.

One or more motors 40 move the arm 10. For example, the arm 10 includes a plurality of motors 41, 42, 43, 44, 45, and 46 as the one or more motors 40. The motors 41, 42, 43, 44, 45, and 46 respectively operate the six-axis joints 31, 32, 33, 34, 35, and 36 to change the position and posture of the distal end portion 18. This changes the position and posture of the distal end portion 18 and the position and posture of the end effector 3.

For example, the motor 41 drives the joint 31 to rotate the rotational portion 12 about the axis 21. The motor 42 drives the joint 32 to swing the first arm 13 about the axis 22. The motor 43 drives the joint 33 to swing the arm base 15 about the axis 23. The motor 44 drives the joint 34 to rotate the arm end 16 about the axis 24. The motor 45 drives the joint 35 to swing the third arm 17 about the axis 25. The motor 46 drives the joint 36 to rotate the distal end portion 18 about the axis 26.

Each of the motors 41, 42, 43, 44, 45, and 46 is, for example, an electric motor. Each of the motors 41, 42, 43, 44, 45, and 46 may directly drive the target to be driven or may drive it through a transmission element such as a speed reducer.

The example configuration of the arm 10 described above is merely an example and can be modified as long as the position and posture of the end effector 3 can be changed. For example, the arm 10 may be a redundant robot with one or more redundant axes added to the six-axis joints described above. The arm 10 may be a SCARA robot or a parallel link robot.

The control device 100 controls the arm 10. For example, the control device 100 operates the motors 41, 42, 43, 44, 45, and 46 to change the position and posture of the end effector 3. Hereinafter, the motors 41, 42, 43, 44, 45, and 46 may be referred to as one or more motors 40.

The control device 100 controls the one or more motors 40 through multiple feedback loops for multiple physical quantities that are in a differential and integral relationship with each other. A physical quantity is a quantity that quantifies a physical phenomenon or state. Examples of multiple physical quantities that are in a differential and integral relationship with each other include position, velocity, and acceleration.

For example, the control device 100 may control the position (for example, rotational angle) of the one or more motors 40 through a position feedback loop, a velocity feedback loop, and an acceleration feedback loop. In such a control system, the position command (target value of position) is determined outside the multiple feedback loops, the velocity command (target value of velocity) is generated by the position feedback loop, and the acceleration command (target value of acceleration) is generated by the velocity feedback loop. For example, the velocity command is generated based on the deviation between the position command and the feedback value in the position feedback loop. The acceleration command is generated based on the deviation between the velocity command and the feedback value in the velocity feedback loop.

The above control system is merely an example, and there may be cases where it is demanded to directly provide control commands to the inner feedback loop from the outside. For example, there may be cases where it is demanded that the position feedback loop and the velocity feedback loop are separated, and that a velocity command is provided to the velocity feedback loop from the outside. Similarly, there may be cases where it is demanded that the velocity feedback loop and the acceleration feedback loop are separated, and that an acceleration control command is provided to the acceleration feedback loop from the outside.

By separating the outer feedback loop and the inner feedback loop and directly providing control commands to the inner feedback loop, more diverse motor control becomes available. However, the physical quantity controlled by the outer feedback loop becomes uncontrollable. Therefore, phenomena in which the end effector 3 is displaced to an unacceptable position or the end effector 3 moves at an unacceptable velocity may occur.

Accordingly, the control device 100 is configured to execute: controlling at least one of the one or more motors 40 of the robot system 1 so that a first control quantity follows a first control command; and limiting the first control command in accordance with a second control quantity that is an integral of the first control quantity. Even in a control system where the feedback loop of the second control quantity is separated from the feedback loop of the first control quantity, the second control quantity can be indirectly limited by limiting the first control quantity in accordance with the second control quantity. Therefore, the first control quantity can be controlled while avoiding the second control quantity from becoming excessive. Accordingly, it is beneficial for more diverse motor control.

Note that “control quantity” means a physical quantity that is the control target. “Control command” means a target value for the physical quantity that is the control target. The same applies hereinafter.

Limiting the first control command is different from determining the first control command by the feedback loop of the second control quantity. For example, when the first control command is limited, the first control command can be determined independently of the second control quantity within the range of the limitation, so it cannot be said that the first control command is determined by the feedback loop of the second control quantity.

In the control of the arm 10, when the first control quantity is velocity, the first control command is a velocity command, and the second control quantity is position. When the first control quantity is acceleration, the first control command is an acceleration command, and the second control quantity is velocity. When the first control quantity is jerk, the first control command is a jerk command, and the second control quantity is acceleration.

For example, the control device 100 includes a motor control unit 111 and a command generation unit 112 as functional components (hereinafter referred to as “functional blocks”). The motor control unit 111 controls at least the one or more motors 40 of the robot system 1 so that the first control quantity follows the first control command. The command generation unit 112 limits the first control command in accordance with a second control quantity that is an integral of the first control quantity. When the command generation unit 112 limits the first control command, the motor control unit 111 controls the one or more motors 40 so that the first control quantity follows the limited first control command.

For example, the command generation unit 112 generates a limit value that decreases as the second control quantity increases and limits the first control command to the limit value or less. The limit of the first control quantity is adjusted in accordance with the magnitude of the second control quantity. Therefore, while the second control quantity is small, the first control command is not limited or is limited relatively little, so the first control quantity can be increased, and the second control quantity can be changed rapidly. When the second control quantity becomes large, the first control command is relatively limited, so the first control quantity becomes small, and the change in the second control quantity can be reduced. The limit value may be generated to change continuously or discontinuously. When the limit value is changed continuously, discontinuous limitations do not occur, and the operation of the robot can be made smoother.

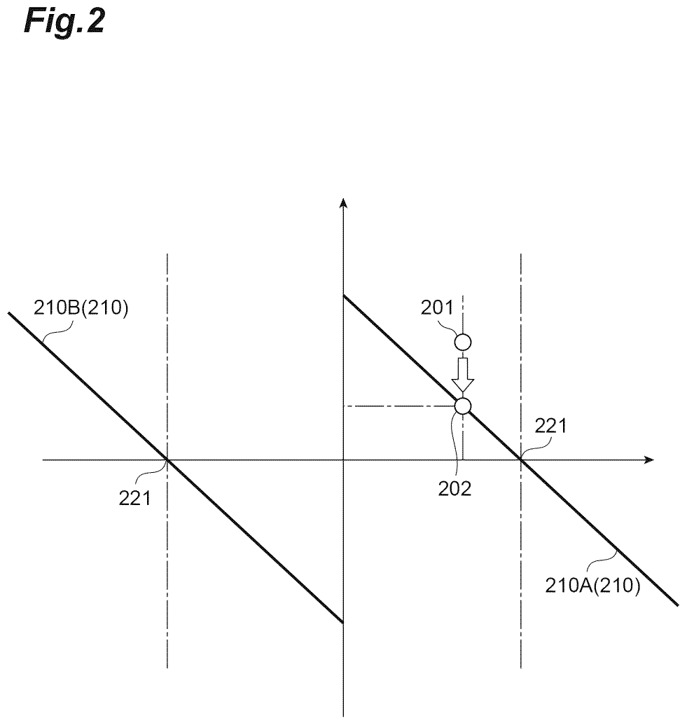

FIG. 2 is a graph illustrating an example limit value that decreases as the second control quantity increases. In FIG. 2, the horizontal axis represents the second control quantity, and the vertical axis represents the first control quantity. The command generation unit 112 stores a limit profile 210. The limit profile 210 represents the relationship between the second control quantity and the limit value such that the limit value gradually decreases as the second control quantity increases. Here, the magnitude refers to the absolute value. Therefore, the limit profile 210 includes a limit profile 210A in the first and fourth quadrants where the second control quantity is positive and a limit profile 210B in the second and third quadrants where the second control quantity is negative. The limit profile 210A and the limit profile 210B are point-symmetric to each other.

As an example, the limit profile 210 is configured so that the limit value gradually decreases as the absolute value of the second control quantity increases, the limit value becomes zero at the position where the second control quantity becomes the second limit value 221, and the sign of the limit value reverses at that position. In the illustration, the limit profile 210 is linear, but it may be nonlinear. The command generation unit 112 may store the limit profile 210 as a function or may store the limit profile 210 as a discrete lookup table.

The command generation unit 112 may directly generate a first control command with an absolute value limited to the limit profile 210 or less, or may correct the absolute value of a provisionally generated first control command to the limit profile 210 or less if the absolute value of the provisionally generated first control command exceeds the limit profile 210. For example, a point 201 in FIG. 2 is a combination of the second control quantity and the first control command provisionally generated by the command generation unit 112. A point 202 is the limit value corresponding to the second control quantity of the point 201 in the limit profile 210. The first control command of the point 201 exceeds the limit value of the point 202. In such a case, the command generation unit 112 corrects the first control command of the point 201 to the limit value of the point 202.

Returning to FIG. 1, the motor control unit 111 may control the one or more motors 40 so that acceleration as the first control quantity follows an acceleration command as the first control command. The command generation unit 112 may generate a limit value that decreases as the velocity as the second control quantity increases and limits the acceleration command to the limit value or less.

A velocity limit can be imposed while performing acceleration control. Therefore, for example, when the robot 2 is performing a force task, the velocity can be prevented from becoming excessive as a result of moving away from the target object.

The acceleration command includes a command for a physical quantity proportional to the acceleration. For example, the torque generated by the one or more motors 40 is proportional to the resulting acceleration of the driven object. Therefore, the acceleration command includes a torque command. Also, since the current supplied to the one or more motors 40 is proportional to the torque, the current is proportional to the resulting acceleration of the driven object. Therefore, the acceleration command includes a current command.

When the acceleration command represents the value of the acceleration itself, the motor control unit 111 calculates the current for generating the acceleration corresponding to the acceleration command in the one or more motors 40 and supplies the calculated current to the one or more motors 40.

The command generation unit 112 may provisionally generate the first control command without being based on the second control quantity. For example, the command generation unit 112 may generate the first control command based on a third control quantity different from the second control quantity while limiting the second control quantity to the limit value or less. For example, the command generation unit 112 may provisionally generate the first control command based on the third control quantity and then limit the provisionally generated first control command to the limit value or less. The third control quantity is different from the second control quantity but similar to the second control quantity in that the third control quantity changes in accordance with the first control quantity.

The third control quantity being different from the second control quantity means that the physical quantities being controlled are different from each other. Different physical quantities mean, for example, that the ratio of one physical quantity to the other is not linear. For example, physical quantities that are in a differential and integral relationship with each other are different. For example, force and position are different, and force and velocity are also different.

As an example, the control device 100 controls the force of the arm 10 of the robot 2 as the third control quantity. For example, the command generation unit 112 may generate an acceleration command so that a force close to the force command is output from the arm 10 while limiting the acceleration command to the limit value or less. The acceleration command can finely control the force while preventing the velocity from becoming excessive.

For example, the command generation unit 112 may provisionally generate an acceleration command so that a force close to the force command is output from the arm 10 (for example, from the end portion of the arm 10) and then limit the provisionally generated acceleration command to the limit value or less. The force of the arm 10 is, for example, the force that the arm 10 exerts on a surrounding object. For example, the force of the arm 10 is the force that the arm 10 exerts on a surrounding object in contact with the arm 10. The surrounding object includes humans.

For example, the command generation unit 112 provisionally generates the acceleration command by the force feedback loop. For example, the command generation unit 112 provisionally generates the acceleration command of the arm 10 by performing proportional calculation, proportional-integral calculation, or proportional-integral-derivative calculation on the deviation between the force command and the force feedback value to reduce the deviation.

The command generation unit 112 calculates the limit value based on the velocity of the arm 10 (fro example, a velocity of the end portion of the arm 10) at the time of provisionally generating the acceleration command and the limit profile, and corrects the acceleration command to the limit value or less if the provisionally generated acceleration command exceeds the limit value. If the provisionally generated acceleration command does not exceed the limit value, the command generation unit 112 uses the provisionally generated acceleration command as the result of generating the acceleration command without correction. The command generation unit 112 converts the acceleration command of the arm 10 into acceleration commands (motor commands) for each of the motors 41, 42, 43, 44, 45, and 46 (hereinafter referred to as “each motor 40”) based on the corrected acceleration command and the structural information of the arm 10.

The motor control unit 111 controls each motor 40 so that the acceleration follows the acceleration command. When the arm 10 is not in contact with a surrounding object, the force feedback value does not approach the force command, but since the acceleration command of the arm 10 is limited to the limit value or less, the velocity of the arm 10 can be prevented from excessively increasing. When the arm 10 comes into contact with a surrounding object, the deviation between the force command and the force feedback value is reduced, and the force of the arm 10 is controlled.

The control device 100 may control the force so that the external force applied to the arm 10 decreases in accordance with the external force. For example, the control device 100 may control the force in accordance with an external force applied to the arm 10 by a human so that the external force decreases. The external force applied to the arm 10 and the force exerted by the arm 10 on the surrounding object (for example, a human) that applied the external force are in an action-reaction relationship. Therefore, the force becomes larger when the external force is applied compared to when no external force is applied. Controlling the force so that the external force decreases corresponds to controlling the force to approach the magnitude of the force when no external force is applied.

For example, the command generation unit 112 generates an acceleration command so that a force close to the force command (for example, zero) when no external force is applied is output from the arm 10. The method for generating the acceleration command so that a force close to the force command is output from the arm 10 is as described above.

By generating an acceleration command so that a force close to the force command when no external force is applied is output from the arm 10, the arm 10 moves in the direction in which the external force acts. Therefore, a human can perform motion teaching on the arm 10 (for example, perform direct teaching) by moving the arm 10 to a desired position by applying an external force to the arm 10. Since the acceleration command is limited to the limit value or less, the velocity of the arm 10 in the direction in which the external force acts can be prevented from excessively increasing.

The control device 100 may further include a superimposition unit 113. The superimposition unit 113 superimposes a high-frequency dither signal on the acceleration command generated by the command generation unit 112. The motor control unit 111 may control the one or more motors 40 so that the acceleration follows the acceleration command on which the dither signal is superimposed. The influence of the force due to static friction can be reduced. The influence of the force includes, for example, fluctuation in the force generated by the arm 10 and deterioration in the accuracy of the estimated value of the force generated by the arm 10 or the external force acting on the arm 10.

The dither signal means a signal superimposed for dithering. Dithering means a process of superimposing a high-frequency dither signal on the control command (for example, the acceleration command) to reduce the sticking caused by static friction and make the movement of the arm 10 smoother.

High frequency means having a frequency higher than the frequency of the acceleration command. For example, the dither signal has a frequency high enough that the arm 10 cannot follow (for example, a frequency higher than the natural frequency of the arm 10).

The control device 100 may further include a force estimation unit 114. The force estimation unit 114 estimates the force acting on the arm 10 based on the acceleration command on which the dither signal is superimposed and the acceleration. When there is no force (for example, external force) acting on the arm 10, the acceleration of the arm 10 follows the acceleration command, so the external force can be estimated based on the difference between the acceleration command and the acceleration. However, when the arm 10 does not move due to static friction, the degree of difference between the acceleration command and the acceleration cannot be grasped, so the accuracy of the external force estimation deteriorates. By superimposing the dither signal, the state where the arm 10 does not move due to static friction is reduced. Accordingly, the decrease in the accuracy of the external force estimation is suppressed.

The command generation unit 112 may generate the acceleration command with setting the force estimated by the force estimation unit 114 as the force feedback value. By using the force estimation result with improved accuracy due to the superimposition of the dither signal, the force can be controlled without sensors.

Note that the command generation unit 112 may generate the acceleration command by setting the force detected by a sensor instead of the estimated force as the force feedback value. The sensor may be a torque sensor that detects the torque acting on at least one of the joints 31, 32, 33, 34, 35, and 36, or a multi-axis force sensor that detects the force acting on the distal end portion 18 or the like of the arm 10.

The control device 100 may control the force pressing the end effector 3 against the workpiece. For example, the command generation unit 112 may generate the acceleration command so that a force close to the force command is output from the end effector 3 to the workpiece while limiting the acceleration command to the limit value or less. The method for generating the acceleration command is as described above. Since the velocity of the end effector 3 moving toward the workpiece is suppressed, the end effector 3 can be prevented from colliding with the workpiece at high speed.

The control device 100 may further include a teaching operation execution unit 115 and a storage unit 116. The teaching operation execution unit 115 causes the arm 10 to perform: an approach operation of moving the end effector 3 in an approach direction to press the end effector 3 against the workpiece; and a search operation of moving the end effector 3 in a search direction intersecting the pressing direction while pressing the end effector 3 against the workpiece in the pressing direction. The storage unit 116 stores at least the pressing direction and the position of the end effector 3 in the search operation as teaching data for a profiling operation. The storage unit 116 may store teaching data for multiple locations in a time series. The command generation unit 112 generates the acceleration command so that the force pressing the workpiece is output from the end effector 3 while limiting the acceleration command to the limit value or less in at least the approach operation. Teaching of the profiling operation can be executed automatically. Collision with the workpiece at high speed during the movement in the approach direction can be prevented.

The command generation unit 112 may generate the acceleration command so that the end effector 3 moves in the search direction while the force is output from the end effector 3 in the pressing direction in the search operation. The state where the end effector 3 is pressed against the workpiece can be readily maintained in the search operation.

The teaching operation execution unit 115 may change the pressing direction to be orthogonal to the search direction in the search operation. The magnitude of the force exerted by the end effector 3 on the workpiece and the speed of movement of the end effector 3 can be stabilized in the search operation.

The teaching operation execution unit 115 may temporarily stop the movement of the end effector 3 and change the pressing direction to be orthogonal to the search direction when detecting a deviation between the direction orthogonal to the pressing direction and the search direction. By temporarily stopping, the frictional force in the search direction can be reduced and the pressing direction can be changed to be orthogonal to the search direction with accuracy. This further stabilizes the magnitude of the force exerted by the end effector 3 on the workpiece and the speed of movement of the end effector 3.

The teaching operation execution unit 115 may store teaching data for multiple locations in the storage unit 116 in a time series. For example, the teaching operation execution unit 115 may store the teaching data for the location where the pressing direction was first determined in the storage unit 116 and then sequentially store the teaching data for the locations where the pressing direction was changed in the storage unit 116.

The teaching operation execution unit 115 may determine to terminate the search operation when the end effector 3 comes closest to a predetermined end position. The term “comes closest” may not be limited to the exact moment of closest approach. For example, the term “comes closest” may mean when it is recognized to have passed the closest position or when it is recognized to be approaching the closest position. When automatically teaching the profiling operation, it is difficult to determine the end position at a position which the end effector 3 actually reaches because the movement path of the end effector 3 is not fixed before teaching. By determining to terminate the search operation when the end effector 3 comes closest to the end position, the end may be defined before the movement path of the end effector 3 is fixed. The term “comes closest” may be determined by calculating the distance between the end position and the end effector 3 and considering the point where the distance is minimized as the end, or by considering the extremum where the distance starts to increase as the end, but may not be limited to these examples.

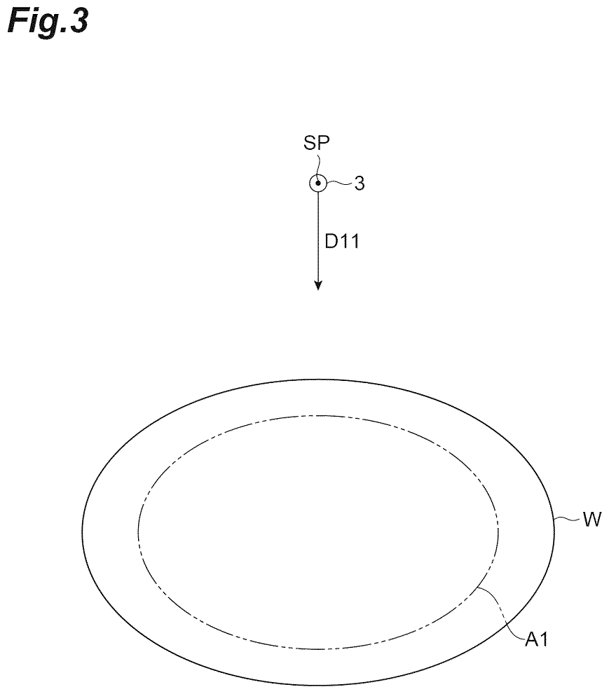

Hereinafter, an example of the teaching operation from the start of the approach operation to the end of the search operation will be illustrated with reference to FIGS. 3 to 6. As illustrated in FIG. 3, the teaching operation execution unit 115 first controls the robot 2 to place the end effector 3 at the start position SP away from the area A1 where the workpiece W is placed. For example, the teaching operation execution unit 115 sequentially generates position commands for the end effector 3 up to the start position SP and inputs them to the command generation unit 112. The command generation unit 112 generates a velocity command for the end effector 3 by the position feedback loop of the end effector 3, generates an acceleration command for the end effector 3 by the velocity feedback loop of the end effector 3, and converts the acceleration command of the end effector 3 into acceleration commands for each motor 40. The motor control unit 111 controls each motor 40 so that the acceleration follows the acceleration command. As a result, the end effector 3 is placed at the start position SP.

Next, the teaching operation execution unit 115 starts the approach operation for the arm 10. For example, the teaching operation execution unit 115 inputs a force command in the approach direction D11 into the command generation unit 112, the approach direction D11 being a direction from the start position SP toward the area A1 (for example, the center of the area A1). The command generation unit 112 generates the acceleration command of the end effector 3 so that a force close to the force command is output from the end effector 3 in the approach direction D11 while limiting the acceleration command to the limit value or less, and converts the acceleration command of the end effector 3 into acceleration commands for each motor 40. The motor control unit 111 controls each motor 40 so that the acceleration follows the acceleration command. As a result, the approach operation is executed.

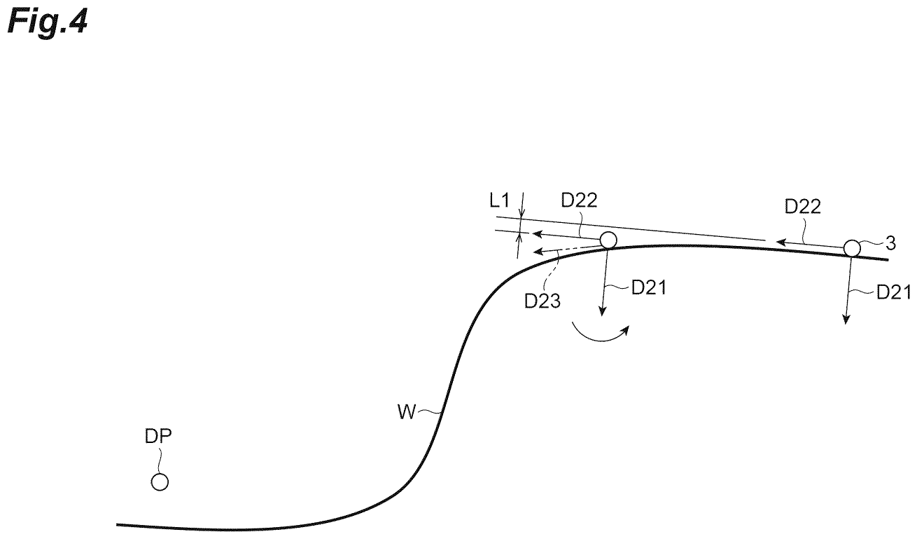

The command generation unit 112 detects that the end effector 3 has pressed against the workpiece W based on the increase in force and notifies the teaching operation execution unit 115. As illustrated in FIG. 4, the teaching operation execution unit 115 detects the pressing direction D21 based on the force feedback value. For example, the teaching operation execution unit 115 detects the direction of the normal force exerted by the end effector 3 on the workpiece W as the pressing direction D21. The teaching operation execution unit 115 may use the approach direction D11 as the pressing direction D21. The teaching operation execution unit 115 stores the teaching data including the force command, the pressing direction D21, and the current position of the end effector 3 in the storage unit 116.

The teaching operation execution unit 115 inputs the pressing direction D21 and a velocity command in the orthogonal orientation D22 perpendicular to the pressing direction D21 to the command generation unit 112. The command generation unit 112 generates the acceleration command of the end effector 3 so that a force close to the force command is output from the end effector 3 in the pressing direction D21 and the end effector 3 moves in the orthogonal orientation D22 at a velocity close to the velocity command, and converts the acceleration command of the end effector 3 into acceleration commands for each motor 40. The motor control unit 111 controls each motor 40 so that the acceleration follows the acceleration command. As a result, the search operation is executed.

The teaching operation execution unit 115 monitors the deviation between the orthogonal orientation D22 and the search direction D23. The deviation between the search direction D23 and the orthogonal orientation D22 occurs when the search direction D23 includes a component along the pressing direction D21. Accordingly, the teaching operation execution unit 115 monitors the deviation between the orthogonal orientation D22 and the search direction D23 based on the displacement quantity of the end effector 3 in the direction along the pressing direction D21. As illustrated in FIG. 4, when the displacement quantity L1 of the end effector 3 in the direction along the pressing direction D21 occurs (for example, when the displacement quantity L1 exceeds a predetermined threshold), the teaching operation execution unit 115 detects the deviation between the orthogonal orientation D22 and the search direction D23.

When the deviation between the orthogonal orientation D22 and the search direction D23 is detected, the teaching operation execution unit 115 temporarily stops the movement of the end effector 3. For example, the teaching operation execution unit 115 sets the velocity command in the orthogonal orientation D22 to zero and inputs the velocity command to the command generation unit 112. In the state where the movement of the end effector 3 is stopped, the teaching operation execution unit 115 changes the pressing direction D21 to be orthogonal to the search direction D23. The teaching operation execution unit 115 stores the teaching data including the force command, the changed pressing direction D21, and the current position of the end effector 3 in the storage unit 116, and inputs the velocity command to the command generation unit 112 to resume the movement of the end effector 3.

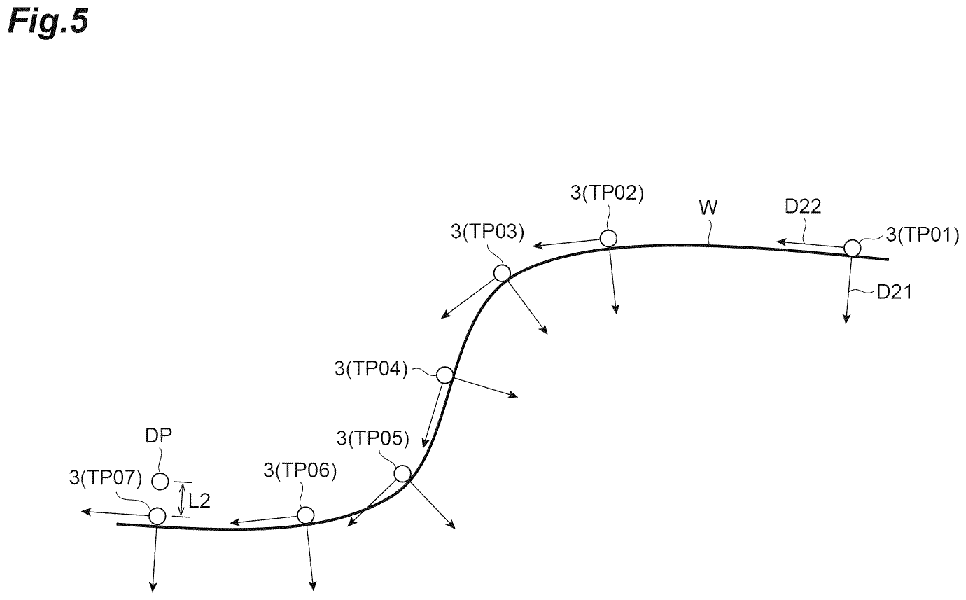

By repeating the change of the pressing direction D21 and the registration of the teaching data each time the deviation between the orthogonal orientation D22 and the search direction D23 is detected, as illustrated in FIG. 5, the storage unit 116 registers the teaching data of multiple taught points TP01 to TP06. The teaching operation execution unit 115 determines to terminate the search operation and stops the movement of the end effector 3 when the end effector 3 comes closest to the predetermined end position DP (for example, when the distance L2 between the end position DP and the end effector 3 is minimized). For example, the teaching operation execution unit 115 sets the velocity command to zero and inputs the velocity command to the command generation unit 112. In the state where the movement of the end effector 3 is stopped, the teaching operation execution unit 115 changes the pressing direction D21 to be orthogonal to the search direction D23. The teaching operation execution unit 115 stores the teaching data including the force command, the changed pressing direction D21, and the current position of the end effector 3 in the storage unit 116. As a result, the teaching data of the taught point TP07 is further registered.

The teaching operation execution unit 115 causes the arm 10 to execute a retreat operation. For example, the teaching operation execution unit 115 sequentially generates position commands for moving away from the area A1 and inputs them to the command generation unit 112. The command generation unit 112 generates a velocity command for the end effector 3 by the position feedback loop of the end effector 3, generates an acceleration command for the end effector 3 by the velocity feedback loop of the end effector 3, and converts the acceleration command of the end effector 3 into acceleration commands for each motor 40. The motor control unit 111 controls each motor 40 so that the acceleration follows the acceleration command. As a result, the end effector 3 moves away from the workpiece W.

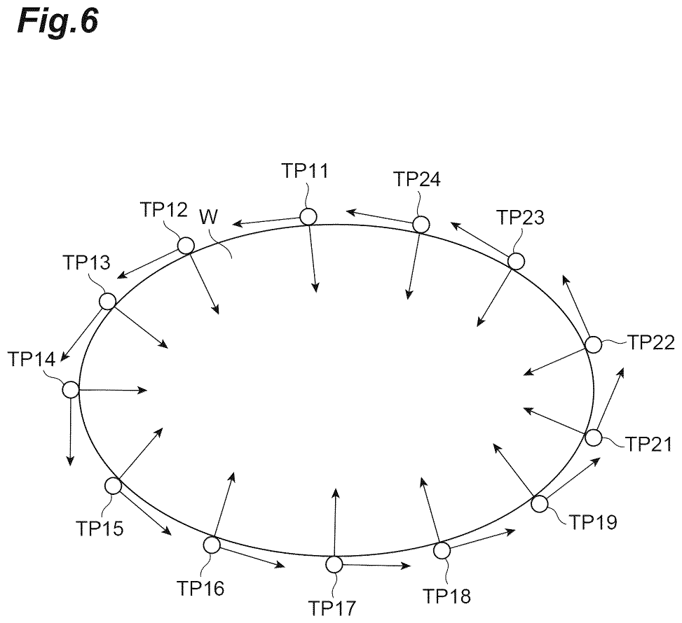

This completes the teaching operation. According to this teaching operation, a profiling operation around the workpiece W can be taught. For example, FIG. 6 illustrates a state in which the teaching data of multiple taught points TP11 to TP24 along a movement path around the workpiece W is registered.

Returning to FIG. 1, the control device 100 may further include a playback unit 117. The playback unit 117 controls the arm 10 to perform a profiling operation on the workpiece W based on the teaching data stored in the storage unit 116. The profiling operation is, for example, an operation of moving the end effector 3, such as a polishing tool, along the workpiece W. The playback unit 117 causes the arm 10 to execute the above-described approach operation to place the end effector 3 at the first taught point, and inputs, into the command generation unit 112, the pressing direction D21, the force command, and the velocity command in the orthogonal orientation D22 at the first taught point. The command generation unit 112 generates the acceleration command of the end effector 3 so that a force close to the force command is output from the end effector 3 in the pressing direction D21 and the end effector 3 moves in the orthogonal orientation D22 at a velocity close to the velocity command, and converts the acceleration command of the end effector 3 into acceleration commands for each motor 40. The motor control unit 111 controls each motor 40 so that the acceleration follows the acceleration command. The playback unit 117 changes the pressing direction to the pressing direction at the next taught point each time the end effector 3 reaches the next taught point. As a result, the profiling operation is executed. When the end effector 3 reaches the last taught point, the playback unit 117 stops the movement of the end effector 3 and causes the arm 10 to execute the retreat operation. This completes the profiling operation.

The above configuration can also be used for other operations besides profiling operations. For example, the configuration can also be used when performing screw tightening by rotating the distal end portion 18 together with a screw tightening tool (an example of the end effector 3).

For example, the command generation unit 112 generates the acceleration command for the motor 46 so that a torque close to the predetermined torque command is output to the screw tightening tool. The superimposition unit 113 superimposes a high-frequency dither signal on the acceleration command generated by the command generation unit 112. The motor control unit 111 controls the motor 46 so that the acceleration follows the acceleration command on which the dither signal is superimposed. The force estimation unit 114 estimates the torque acting on the screw tightening tool based on the acceleration command on which the dither signal is superimposed and the acceleration. The command generation unit 112 generates the acceleration command based on the estimated torque as the feedback value. As a result, screw tightening is executed with a torque that follows the torque command.

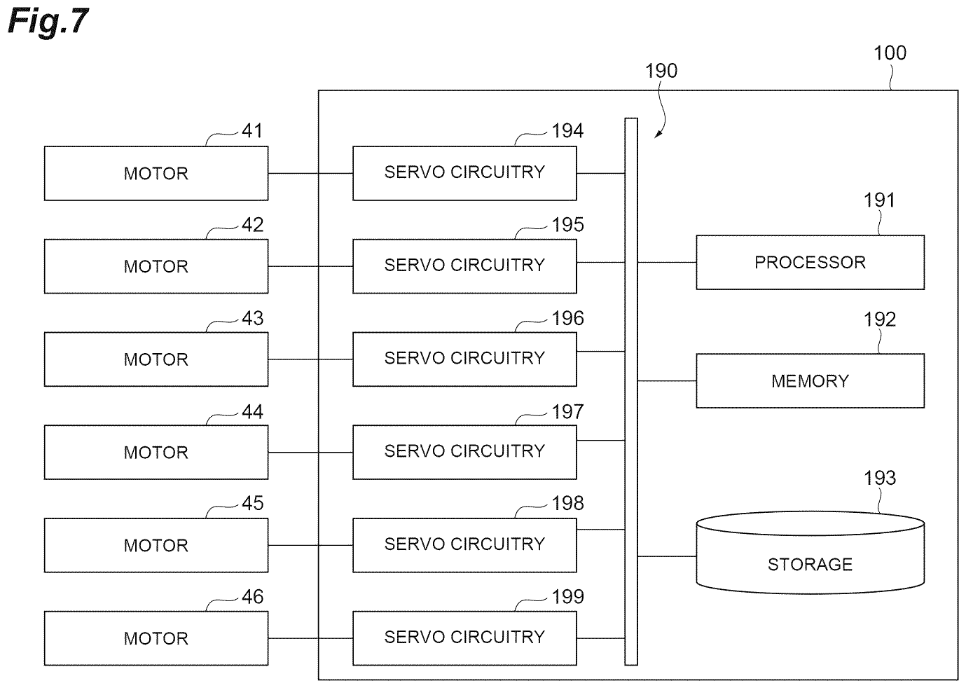

FIG. 7 is a block diagram illustrating an example hardware configuration of the control device 100. As illustrated in FIG. 7, the control device 100 includes circuitry 190. The circuitry 190 includes a processor 191, a memory 192, a storage 193, and servo circuitry 194, 195, 196, 197, 198, and 199.

The storage 193 stores a program for causing the control device 100 to execute: controlling at least one of the motors 40 of the robot system 1 so that the first control quantity follows the first control command; and limiting the first control command in accordance with a second control quantity that is an integral of the first control quantity. For example, the storage 193 stores a program for configuring each functional block described above in the control device 100.

The storage 193 includes one or more storage devices. The storage devices are, for example, non-volatile storage media such as hard disk drives or flash memories. The storage devices may include portable media such as optical disks and magnetic disks.

The memory 192 temporarily stores the program loaded from the storage 193. The memory 192 includes one or more memory devices. The memory devices are, for example, volatile storage media such as random-access memory (RAM).

The processor 191 executes the program loaded into the memory 192 to configure each functional block described above in the control device 100. The data generated by the processor 191 may be stored in the memory 192. The servo circuitry 194, 195, 196, 197, 198, and 199 supply current to the motors 41, 42, 43, 44, 45, and 46 based on requests from the processor 191. The hardware configuration of the control device 100 is not limited to the above and can be modified. For example, all functions of the control device 100 may not be executed by the execution of programs, and at least some of the functions may be configured by dedicated logic circuits such as application-specific integrated circuits (ASICs).

### Control Procedure

As an example of the control method, an example control procedure executed by the control device 100 will be illustrated. This control procedure includes: controlling at least one motor of the robot system 1 so that the first control quantity follows the first control command; and limiting the first control command in accordance with the second control quantity that is an integral of the first control quantity.

The control procedure includes a motor control procedure, a teaching operation procedure, and a playback control procedure. The teaching operation procedure and the playback control procedure are executed in parallel with the motor control procedure. Each procedure will be illustrated below.

### Motor Control Procedure

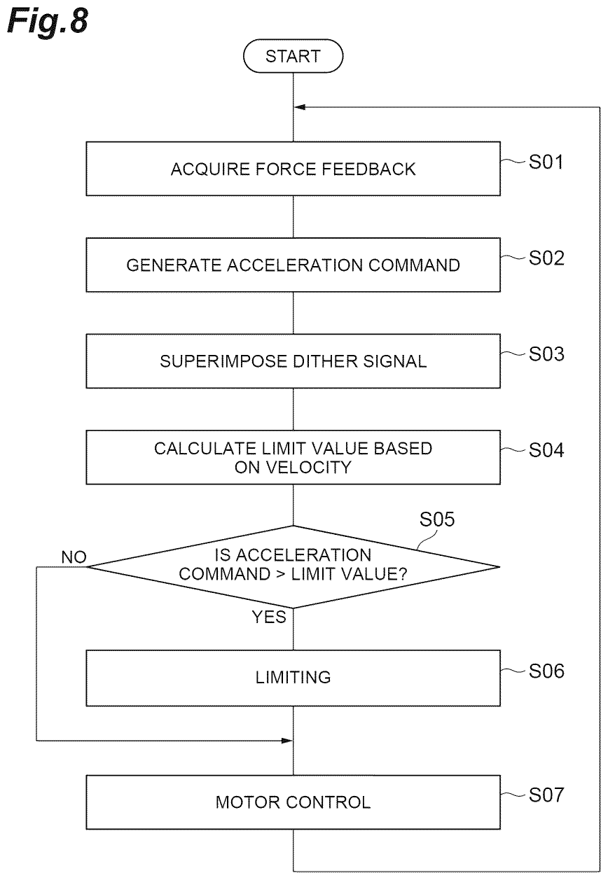

This procedure controls the force of the arm 10 of the robot 2. As illustrated in FIG. 8, the control device 100 executes operations S01, S02, and S03. In operation S01, the command generation unit 112 acquires the feedback value of the force (for example, the force exerted by the end effector 3 on the workpiece). For example, the command generation unit 112 acquires the estimated force value from the force estimation unit 114. In operation S02, the command generation unit 112 provisionally generates the acceleration command of the arm 10 to reduce the deviation between the force command and the force feedback value. In operation S03, the superimposition unit 113 superimposes the dither signal on the acceleration command.

Next, the control device 100 executes operations S04 and S05. In operation S04, the command generation unit 112 calculates the limit value based on the velocity of the arm 10 and the limit profile. In operation S05, the command generation unit 112 checks whether the provisionally generated acceleration command exceeds the limit value.

If it is determined in operation S05 that the acceleration command exceeds the limit value, the control device 100 executes operation S06. In operation S06, the command generation unit 112 corrects the acceleration command to the limit value.

Next, the control device 100 executes operation S07. If it is determined in operation S05 that the acceleration command does not exceed the limit value, the control device 100 skips operation S06 and directly executes operation S07. In operation S07, the command generation unit 112 converts the acceleration command of the arm 10 into acceleration commands for each motor 40, and the motor control unit 111 controls each motor 40 so that the acceleration follows the acceleration command. Thereafter, the control device 100 returns the process to operation S01. The control device 100 repeats the above procedure.

### Teaching Operation Procedure

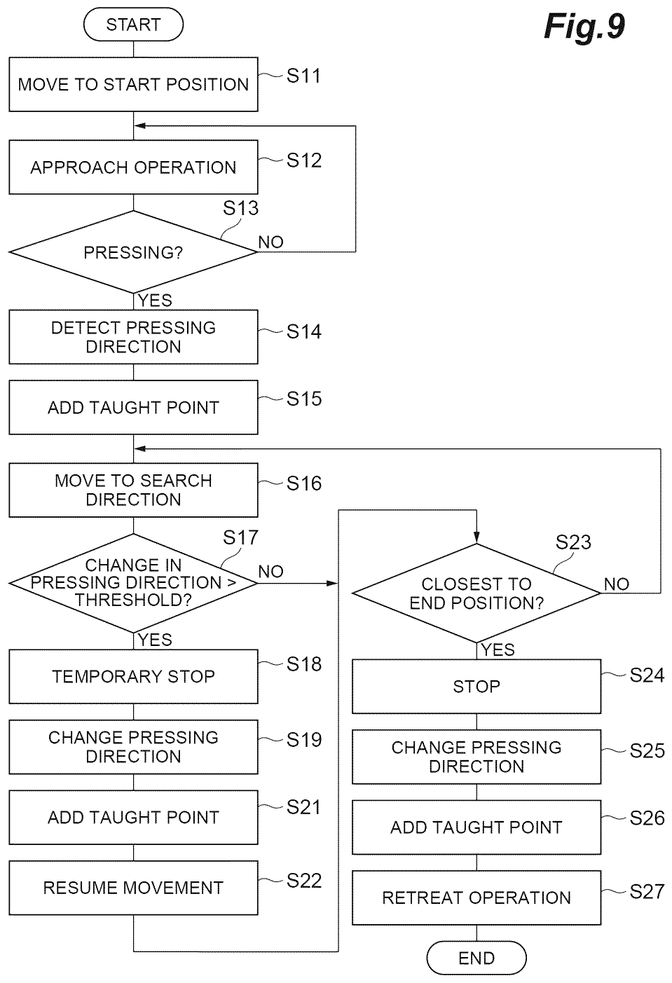

This procedure is a procedure for causing the arm 10 to execute the approach operation and the search operation by the motor control procedure described above. As illustrated in FIG. 9, the control device 100 first executes operations S11, S12, and S13. In operation S11, the teaching operation execution unit 115 controls the robot 2 to place the end effector 3 at the start position SP of the approach operation. In operation S12, the teaching operation execution unit 115 inputs the force command in the approach direction into the command generation unit 112. The command generation unit 112 generates the acceleration command of the end effector 3 so that a force close to the force command is output from the end effector 3 in the approach direction D11 while limiting the acceleration command to the limit value or less, and converts the acceleration command of the end effector 3 into acceleration commands for each motor 40. The motor control unit 111 controls each motor 40 so that the acceleration follows the acceleration command. As a result, the approach operation is executed. In operation S13, the command generation unit 112 checks whether the end effector 3 has been pressed against the workpiece W based on the force feedback value. If it is determined in operation S13 that the end effector 3 has not been pressed against the workpiece W, the control device 100 returns the process to operation S12. Thereafter, the approach operation continues until the end effector 3 is pressed against the workpiece W.

Next, the control device 100 executes operations S14, S15, and S16. In operation S14, the teaching operation execution unit 115 detects the pressing direction D21 based on the force feedback value. In operation S15, the teaching operation execution unit 115 stores the teaching data including the force command, the pressing direction D21, and the current position of the end effector 3 in the storage unit 116. In operation S16, the teaching operation execution unit 115 inputs, into the command generation unit 112, the pressing direction D21 and the velocity command in the orthogonal orientation D22, the orthogonal orientation D22 being perpendicular to the pressing direction D21. The command generation unit 112 generates the acceleration command of the end effector 3 so that a force close to the force command is output from the end effector 3 in the pressing direction D21 and the end effector 3 moves in the orthogonal orientation D22 at a velocity close to the velocity command, and converts the acceleration command of the end effector 3 into acceleration commands for each motor 40. The motor control unit 111 controls each motor 40 so that the acceleration follows the acceleration command. As a result, the search operation is executed.

Next, the control device 100 executes operation S17. In operation S17, the teaching operation execution unit 115 checks whether the displacement quantity of the end effector 3 in the direction along the pressing direction D21 exceeds the threshold.

If it is determined in operation S17 that the displacement quantity of the end effector 3 exceeds the threshold, the control device 100 executes operations S18, S19, S21, and S22. In operation S18, the teaching operation execution unit 115 temporarily stops the movement of the end effector 3. In operation S19, the teaching operation execution unit 115 changes the pressing direction D21 to be orthogonal to the search direction D23. In operation S21, the teaching operation execution unit 115 stores the teaching data including the force command, the pressing direction D21, and the current position of the end effector 3 in the storage unit 116. In operation S22, the teaching operation execution unit 115 resumes the movement of the end effector 3.

Next, the control device 100 executes operation S23. If it is determined in operation S17 that the displacement quantity of the end effector 3 does not exceed the threshold, the control device 100 skips operations S18, S19, S21, and S22 and directly executes operation S23. In operation S23, the teaching operation execution unit 115 checks whether the end effector 3 has come closest to the end position DP (for example, whether the distance between the end effector 3 and the end position DP is minimized). If it is determined in operation S23 that the end effector 3 has not come closest to the end position DP, the control device 100 returns the process to operation S15. Thereafter, the search operation continues until the end effector 3 comes closest to the end position DP.

If it is determined in operation S23 that the end effector 3 has come closest to the end position DP, the control device 100 executes operations S24, S25, S26, and S27. In operation S24, the teaching operation execution unit 115 stops the movement of the end effector 3. In operation S25, the teaching operation execution unit 115 changes the pressing direction D21 to be orthogonal to the search direction D23. In operation S26, the teaching operation execution unit 115 stores the teaching data including the force command, the pressing direction D21, and the current position of the end effector 3 in the storage unit 116. In operation S27, the teaching operation execution unit 115 executes the retreat operation for the arm 10. This completes the teaching operation procedure.

### Playback Control Procedure

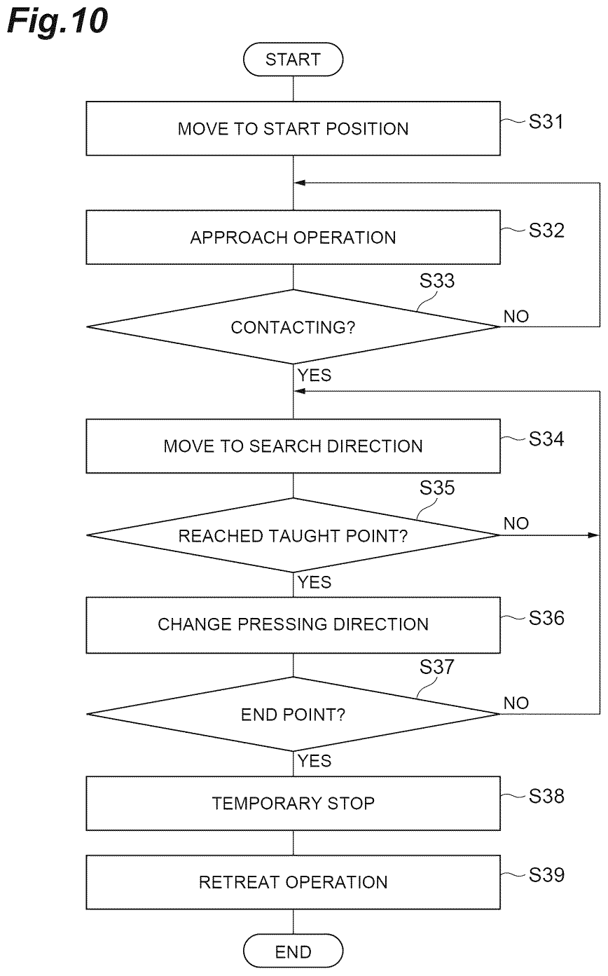

This procedure is a procedure for causing the arm 10 to execute the profiling operation by the motor control procedure described above based on the teaching data registered in the storage unit 116. As illustrated in FIG. 10, the control device 100 executes operations S31, S32, and S33. In operation S31, the playback unit 117 controls the robot 2 to place the end effector 3 at the start position SP of the approach operation. In operation S32, the playback unit 117 inputs the force command for the first taught point to the command generation unit 112. In operation S33, the command generation unit 112 checks whether the end effector 3 has been pressed against the workpiece W at the first taught point based on the force feedback value. If it is determined in operation S33 that the end effector 3 has not been pressed against the workpiece W, the control device 100 returns the process to operation S32. Thereafter, the approach operation continues until the end effector 3 is pressed against the workpiece W.

If it is determined in operation S33 that the end effector 3 has been pressed against the workpiece W, the control device 100 executes operations S34 and S35. In operation S34, the playback unit 117 inputs, into the command generation unit 112, the pressing direction D21, the force command, and the velocity command in the orthogonal orientation D22 at the first taught point. The command generation unit 112 generates the acceleration command of the end effector 3 so that a force close to the force command is output from the end effector 3 in the pressing direction D21 and the end effector 3 moves in the orthogonal orientation D22 at a velocity close to the velocity command, and converts the acceleration command of the end effector 3 into acceleration commands for each motor 40. The motor control unit 111 controls each motor 40 so that the acceleration follows the acceleration command. As a result, the profiling operation is executed.

In operation S35, the playback unit 117 checks whether the end effector 3 has reached the next taught point. If it is determined in operation S35 that the end effector 3 has not reached the next taught point, the control device 100 returns the process to operation S34 to continue the profiling operation.

If it is determined in operation S35 that the end effector 3 has reached the next taught point, the control device 100 executes operation S36. In operation S36, the playback unit 117 inputs, into the command generation unit 112, the pressing direction D21, the force command, and the velocity command in the orthogonal orientation D22 at the reached taught point. As a result, the profiling operation continues by changing the pressing direction D21.

Next, the control device 100 executes operation S37. In operation S37, the playback unit 117 checks whether the end effector 3 has reached the final taught point. If it is determined in operation S37 that the end effector 3 has not reached the final taught point, the control device 100 returns the process to operation S34 to continue the profiling operation. If it is determined in operation S37 that the end effector 3 has reached the final taught point, the control device 100 executes operations S38 and S39. In operation S38, the playback unit 117 stops the movement of the end effector 3. In operation S39, the playback unit 117 causes the arm 10 to execute the retreat operation. This completes the playback control procedure.

### Other Teaching Operation Procedure

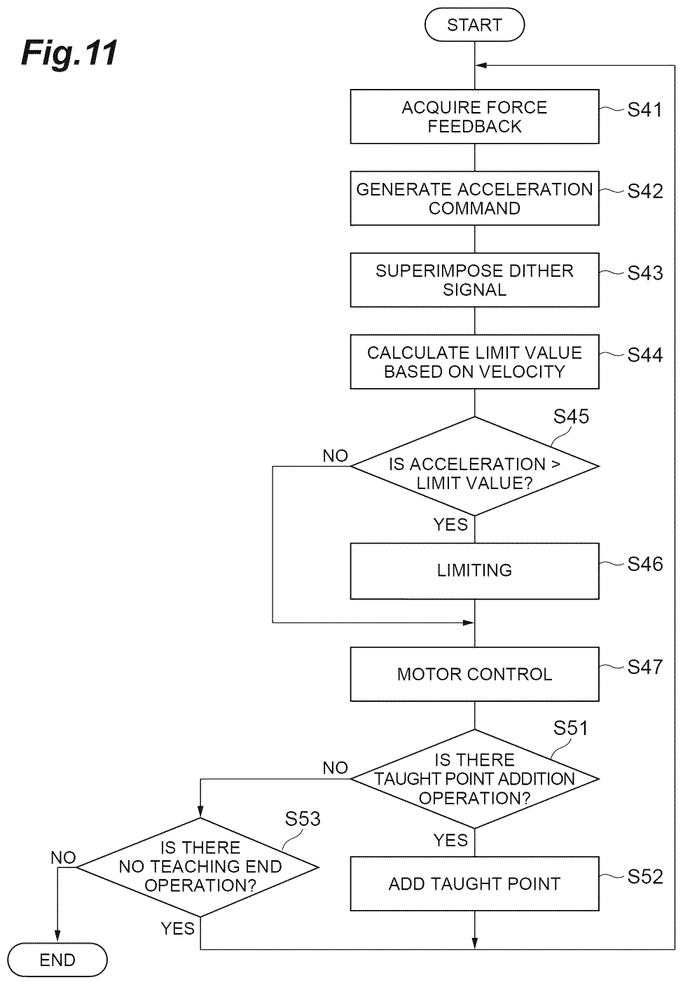

FIG. 11 is a flowchart illustrating an example teaching operation procedure executed by the control device 100 in direct teaching in which a human applies an external force to the arm 10. As illustrated in FIG. 11, the control device 100 first executes operations S41 to S47, which are similar to operations S01 to S07 (motor control procedure). In operation S42, the command generation unit 112 provisionally generates the acceleration command of the arm 10 with the force command set to a value (for example, zero) when no external force is applied.

After operation S47, the control device 100 executes operation S51. In operation S51, the command generation unit 112 checks whether a teaching point addition operation is performed by the user. The addition operation is input by a user interface (for example, a teaching pendant) that can communicate with the control device 100. If it is determined in operation S51 that the teaching point addition operation is performed, the control device 100 executes operation S52. In operation S52, the command generation unit 112 stores the teaching point (for example, the current position of the end effector 3) in the storage unit 116. Thereafter, the control device 100 returns the process to operation S41 to continue the direct teaching.

If it is determined in operation S51 that the teaching point addition operation is not performed, the control device 100 executes operation S53. The command generation unit 112 checks whether the direct teaching end operation is performed by the user. The end operation is input by, for example, the user interface. If it is determined in operation S53 that the end operation is not performed, the control device 100 returns the process to operation S41 to continue the direct teaching. If it is determined in operation S53 that the end operation is performed, the control device 100 ends the direct teaching.

### Screw Tightening Control Procedure

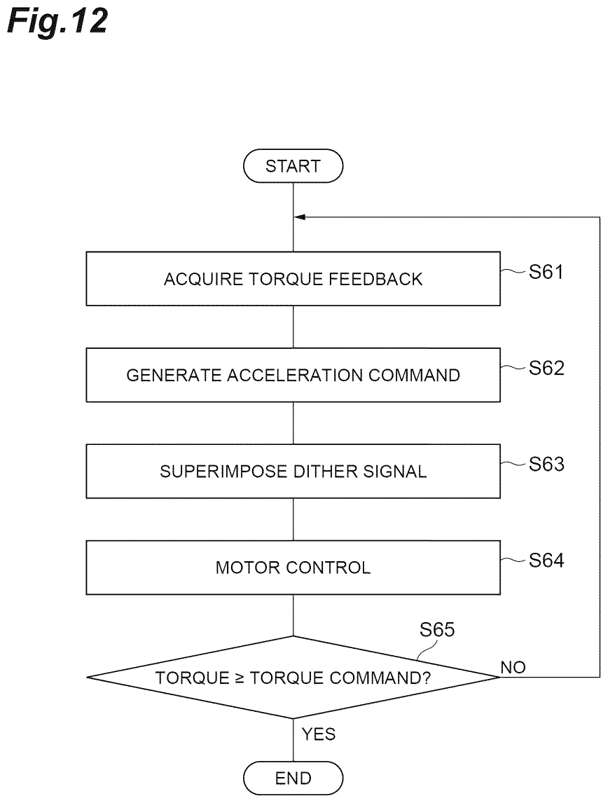

FIG. 12 is a flowchart illustrating an example screw tightening control procedure executed by the end effector 3, such as a screw tightening tool. This procedure is executed in a state where the end effector 3 rotating together with the distal end portion 18 is engaged with a bolt or the like. As illustrated in FIG. 12, the control device 100 executes operations S61, S62, S63, S64, and S65. In operation S61, the command generation unit 112 acquires the feedback value of the torque acting on the end effector 3 from the force estimation unit 114. In operation S62, the command generation unit 112 generates the acceleration command for the motor 46 so that a torque close to the predetermined torque command is output to the end effector 3. In operation S63, the superimposition unit 113 superimposes the dither signal on the acceleration command for the motor 46. In operation S64, the motor control unit 111 controls the motor 46 so that the acceleration follows the acceleration command on which the dither signal is superimposed. In operation S65, the command generation unit 112 checks whether the feedback value of the torque has reached the torque command. If it is determined in operation S65 that the feedback value of the torque has not reached the torque command, the control device 100 returns the process to operation S61 to continue the screw tightening control. If it is determined in operation S65 that the feedback value of the torque has reached the torque command, the control device 100 completes the screw tightening control procedure.

The above disclosure includes the following configurations:
(1) A robot system 1 comprising: a robot comprising one or more motors 40 configured to move an arm 10; and a control device 100 configured to control the robot, wherein the control device 100 comprises: a motor control unit 111 configured to control at least one motor so that a first control quantity follows a first control command; and a command generation unit 112 configured to limit the first control command in accordance with a second control quantity that is an integral of the first control quantity.

The first control quantity, which is the derivative of the second control quantity, may be more suitable for an aim of control than the second control quantity. However, when the first control quantity is the control target, it is difficult to limit the second control quantity, which is the integral of the first control quantity, and the second control quantity may become excessive. On the other hand, by providing a limiter that corrects the first control command of the first control quantity so that the second control quantity does not exceed the limit value, the first control quantity can be controlled while avoiding the second control quantity from becoming excessive. Accordingly, it is beneficial for more diverse motor control.
(2) The robot system 1 according to (1), wherein the command generation unit 112 is configured to generate a limit value that decreases as the second control quantity increases and to limit the first control command to the limit value or less.

The limit of the first control quantity is adjusted in accordance with the magnitude of the second control quantity. Accordingly, while the second control quantity is small, the first control command is not limited or is limited relatively little, so the first control quantity can be increased, and the second control quantity can be changed rapidly. When the second control quantity becomes large, the first control command is relatively limited, so the first control quantity becomes small, and the change in the second control quantity can be reduced. The limit value may be generated to change continuously or discontinuously. When the limit value is changed continuously, discontinuous limitations do not occur, and the operation of the robot can be made smoother.
(3) The robot system 1 according to (2), wherein the motor control unit 111 is configured to control the motor so that acceleration as the first control quantity follows an acceleration command as the first control command, and wherein the command generation unit 112 is configured to: generate the limit value that decreases as a velocity as the second control quantity increases; and limit the acceleration command to the limit value or less.

A velocity limit can be imposed while performing acceleration control. Accordingly, for example, when the robot is performing a physical work, the velocity can be prevented from becoming excessive as a result of moving away from the target object.
(4) The robot system 1 according to (3), wherein the control device 100 is configured to control a force of the arm 10 of the robot, and wherein the command generation unit 112 is configured to generate the acceleration command so that the force is output from the arm 10 while limiting the acceleration command to the limit value or less.

The acceleration command can finely control the force while preventing the velocity from becoming excessive.
(5) The robot system 1 according to (4), wherein the control device 100 is configured to control the force so that an external force applied to the arm 10 decreases in accordance with the external force. According to the robot system 1, for example, when a human wants to move the position of the arm 10, such as in direct teaching, the velocity can be prevented from excessively increasing due to the external force applied by the human.
(6) The robot system 1 according to (4) or (5), further comprising a superimposition unit 113 configured to superimpose a high-frequency dither signal on the acceleration command generated by the command generation unit 112, wherein the motor control unit 111 is configured to control the motor so that the acceleration follows the acceleration command on which the dither signal is superimposed.

The influence of the force due to static friction can be reduced. The influence of the force includes, for example, fluctuation of the force generated by the arm 10, and deterioration of the accuracy of the estimated value of the force generated by the arm 10 or the external force acting on the arm 10.
(7) The robot system 1 according to (6), further comprising a force estimation unit 114 configured to estimate a force acting on the arm 10 based on the acceleration command on which the dither signal is superimposed and the acceleration.

The force can be estimated accurately. By using the estimated force to control the force of the arm 10, sensorless control can be achieved.
(8) The robot system 1 according to any one of (4) to (7), further comprising an end effector 3 attached to a tip of the arm 10 and configured to act on a workpiece, wherein the control device 100 is configured to control a force pressing the end effector 3 against the workpiece.

Even when moving away from the workpiece, collision with the workpiece at high speed can be prevented.
(9) The robot system 1 according to (8), wherein the control device 100 comprises: a teaching operation execution unit 115 configured to cause the robot to execute: an approach operation of moving the end effector 3 in an approach direction to press the end effector 3 against the workpiece; and a search operation of moving the end effector 3 in a search direction intersecting the pressing direction while pressing the end effector 3 against the workpiece in the pressing direction; and a storage unit 116 configured to store at least the pressing direction and a position of the end effector 3 in the search operation as teaching data for a profiling operation, wherein the command generation unit 112 is configured to generate the acceleration command so that the force pressing the workpiece is output from the end effector 3 while limiting the acceleration command to the limit value or less at least in the approach operation.

Teaching of the profiling operation can be performed automatically. The end effector 3 can be prevented from colliding with the workpiece at high speed during the movement in the approach direction.
(10) The robot system 1 according to (9), wherein the teaching operation execution unit 115 is configured to determine to terminate the search operation when the end effector 3 comes closest to a predetermined end position.

When automatically teaching the profiling operation, it is difficult to determine the end condition because a fixed position is not always passed through. In the robot system 1, by determining the end of the search operation when the end effector 3 comes closest to the end position, the end can readily be defined. The term “comes closest” may be determined by calculating the distance between the end position and the end effector 3 and considering the point where the distance is minimized as the end, or by considering the extremum where the distance starts to increase as the end, but these examples are not limiting.
(11) The robot system 1 according to (9) or (10), wherein the command generation unit 112 is configured to generate the acceleration command so that the end effector 3 moves in the search direction while the force is output from the end effector 3 in the pressing direction in the search operation.

The state where the end effector 3 is pressed against the workpiece can be readily maintained in the search operation.
(12) The robot system 1 according to (11), wherein the teaching operation execution unit 115 is configured to change the pressing direction to be orthogonal to the search direction in the search operation. The magnitude of the force exerted by the end effector 3 on the workpiece and the speed of movement of the end effector 3 in the search operation can be stabilized.
(13) The robot system 1 according to (12), wherein the teaching operation execution unit 115 is configured to temporarily stop moving the end effector 3 and change the pressing direction to be orthogonal to the search direction when detecting a deviation between the direction orthogonal to the pressing direction and the search direction.

By temporarily stopping, the frictional force in the search direction can be reduced and the pressing direction can be changed to be orthogonal to the search direction with accuracy. This further stabilizes the magnitude of the force exerted by the end effector 3 on the workpiece and the speed of movement of the end effector 3.
(14) A control method comprising: controlling at least one motor so that a first control quantity follows a first control command; and limiting the first control command in accordance with a second control quantity that is an integral of the first control quantity.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A robot system comprising:
a robot comprising one or more motors configured to move an arm; and
circuitry configured to:
control at least one motor of the one or more motors so that a first control quantity follows a first control command, wherein the first control quantity represents a physical status of the arm; and
limit the first control command based on a second control quantity that is an integral of the first control quantity.

2. The robot system according to claim 1, wherein the circuitry is configured to generate a limit value that decreases as the second control quantity increases and to limit the first control command to be equal to or less than the limit value.

3. The robot system according to claim 2, wherein the circuitry is configured to:
control the at least one motor so that an acceleration of the arm as the first control quantity follows an acceleration command as the first control command;
generate the limit value that decreases as a velocity of the arm as the second control quantity increases; and
limit the acceleration command to be equal to or less than the limit value.

4. The robot system according to claim 3, wherein the circuitry is configured to:
generate the acceleration command to control a force output from the arm while limiting the acceleration command to be equal to or less than the limit value.

5. The robot system according to claim 3, wherein the circuitry is configured to generate the acceleration command to decrease an external force applied to the arm while limiting the acceleration command to be equal to or less than the limit value.

6. The robot system according to claim 4, wherein the circuitry is further configured to:
superimpose a high-frequency dither signal on the acceleration command; and
control the at least one motor so that the acceleration follows the acceleration command including the dither signal.

7. The robot system according to claim 6, wherein the circuitry is further configured to estimate the force based on the acceleration command including the dither signal and the acceleration.

8. The robot system according to claim 4, further comprising an end effector attached to a tip of the arm and configured to act on a workpiece,
wherein the circuitry is configured to generate the acceleration command to control the force to press the end effector against the workpiece.

9. The robot system according to claim 3, wherein the circuitry is configured to:
generate the acceleration command to move an end effector toward a workpiece, while limiting the acceleration command to be equal to or less than the limit value, to press the end effector against the workpiece; and
cause the robot to execute a search operation to move the end effector along a search orientation intersecting a pressing orientation while pressing the end effector against the workpiece along the pressing orientation; and
store combinations of the pressing orientation and a position of the end effector in the search orientation during the search operation, wherein the stored combinations are used as taught data for controlling the robot to move the end effector along a profile of the workpiece.

10. The robot system according to claim 9, wherein the circuitry is configured to:
store a predetermined end position located away from the profile of the workpiece;
calculate a distance from the end effector to the predetermined end position as the end effector moves along the profile of the workpiece; and
terminate the search operation in response to determining, based on the distance, that the end effector comes closest to the predetermined end position.

11. The robot system according to claim 9, wherein the circuitry is configured to generate the acceleration command to move the end effector along the search orientation while controlling a force to press the end effector along the pressing orientation.

12. The robot system according to claim 11, wherein the circuitry is configured to change the pressing orientation to be orthogonal to the search orientation during the search operation.

13. The robot system according to claim 12, wherein the circuitry is configured to temporarily stop moving the end effector and change the pressing orientation to be orthogonal to the search orientation in response to detecting a deviation between an orientation orthogonal to the pressing orientation and the search orientation.

14. The robot system according to claim 1, wherein the robot comprises a plurality of motors as the one or more motors; and
the circuitry is configured to:
control the plurality of motors so that the first control quantity follows the first control command, wherein the first control quantity represents a physical status of an end portion of the arm; and
limit the first control command based on a second control quantity that is an integral of the first control quantity.

15. The robot system according to claim 14, wherein the circuitry is configured to:
control the plurality of motors so that an acceleration of the end portion of the arm as the first control quantity follows an acceleration command as the first control command; and
generate a limit value that decreases as a velocity of the end portion of the arm as the second control quantity increases; and
limit the acceleration command to be equal to or less than the limit value.

16. The robot system according to claim 15, wherein the circuitry is configured to generate the acceleration command to control a force output from the end portion of the arm while limiting the acceleration command to be equal to or less than the limit value.

17. The robot system according to claim 15, wherein the circuitry is configured to generate the acceleration command to decrease an external force applied to the end portion of the arm while limiting the acceleration command to be equal to or less than the limit value.

18. The robot system according to claim 15, wherein the circuitry is configured to:
calculate, for each of the plurality of motors, a motor command corresponding to the acceleration command based on a structure of the arm and the acceleration command; and
control each of the plurality of motors so that an acceleration of each of the plurality of motors follows the motor command so that the acceleration of the end portion of the arm follows the acceleration command.

19. A control method for controlling a robot comprising one or motors configured to move an arm; the method comprising:
controlling at least one motor of the one or more motors so that a first control quantity follows a first control command, wherein the first control quantity represents a physical status of the arm; and
limiting the first control command based on a second control quantity that is an integral of the first control quantity.

20. The control method according to claim 19, wherein said controlling includes controlling the at least one motor so that an acceleration of the arm as the first control quantity follows an acceleration command as the first control command,
wherein the method further comprises generating a limit value that decreases as a velocity of the arm as the second control quantity increases, and
wherein said limiting includes limiting the acceleration command to be equal to or less than the limit value.
